(19) United States
(12) Patent Application Publication
(10) Pub. No.: US 2015/0039980 A1
(43) Pub. Date: Feb. 5, 2015

(54) METHOD AND SYSTEM OF CONSUMER ACTIVITY TRACKING

(71) Applicant: CREDITCARDS.COM, INC., Austin, TX (US)

(72) Inventors: Cesar A. GONZALEZ, Cedar Park, TX (US); Imad M. AHMED, Austin, TX (US)

(73) Assignee: CREDITCARDS.COM, INC., Austin, TX (US)

(21) Appl. No.: 13/956,109

(22) Filed: Jul. 31, 2013

(51) Int. Cl. H04L 29/08; G06F 17/22

(52) U.S. Cl. CPC H04L 67/02; G06F 17/2247
USPC 715/205; 709/217; 715/234

(57) ABSTRACT

Consumer activity tracking. Example embodiments include: providing a first web page to a consumer's from a first entity, the first web page showing a product; placing a first beacon packet on the consumer, the first beacon packet indicating the consumer was shown the product by way of first web page; providing a second web page to the consumer, the providing the second web page from a second entity, the second web page showing the product, and a request for the second web page does not include attribution of the request; initiating acquisition of the product by the consumer by way of an acquisition web page provided from the second entity; determining, by the second entity, that the consumer was shown the product by way of the first web page prior to initiating acquisition by the consumer; and attributing advertising credit to the first entity responsive to the determining.

### BACKGROUND

One business model for online sales and advertising is to operate an “aggregator” website, where the products and/or services from several different vendors are advertised and available for purchase directly from the aggregator website. An example of an aggregator website is “orbitz.com”, which aggregates airline flights from several different airlines, gives the consumer the ability to compare schedules and prices, and gives the consumer the ability to purchase tickets directly on the website. Another example of an aggregator website “kayak.com”. The aggregator websites get commissions for the sales.

One of the difficulties faced by aggregator websites is consumers using the aggregator website to compare schedules, prices, availability, etc., but then the consumer going directly to the actual vendor website of the product and/or service for purchase. More particularly, the consumer views the product and/or services on the aggregator website, but then navigates to the vendor's website in such a way that the vendor is not aware that the consumer was introduced to the product and/or service by the aggregator. For example, after identifying a Southwest Airlines flight of interest on the aggregator website, the consumer may navigate directly to airline website by typing “www.southwest.com”, or by searching “Southwest Airlines” in a search engine and selecting the website from the search results. Regardless, in arriving at the example “www.southwest.com” website in one of these manners, no advertising credit is attributed to the aggregator website.

### BRIEF DESCRIPTION OF THE DRAWINGS

For a detailed description of exemplary embodiments, reference will now be made to the accompanying drawings in which:

FIG. 1 shows an example system in accordance with various embodiments;

FIG. 2 shows an example exchange of messages in accordance with at least some embodiments;

FIG. 3 shows an example exchange of messages in accordance with at least some embodiments;

FIG. 4 shows a method accordance with at least some embodiments;

FIG. 5 shows a method accordance with at least some embodiments;

FIG. 6 shows a method accordance with at least some embodiments; and

FIG. 7 shows a computer system in accordance with at least some embodiments.

### NOTATION AND NOMENCLATURE

Certain terms are used throughout the following description and claims to refer to particular hardware and software components. As one skilled in the art will appreciate, different companies may refer to components by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Entity”, with respect to providing of web pages, shall refer to a legal entity (e.g., corporation, individual person).

“Providing a web page . . . from a [particular] entity” shall mean that the web page is provided from a computer system owned, rented, or leased by the entity. In situations where web pages are provided from a “cloud computing” service, use of cloud computing resources for a fee paid by the entity shall be considered “owned, rented, or leased” even though the precise location of the computer systems may not be known by the entity, or may change with time or loading.

“First web page . . . second web page” shall refer to web pages where at least fifty percent (50%) of the content measured in bytes (e.g., pictures, text) is different. The fact that two web pages may contain partial duplicate coding shall not obviate that the web pages are different.

“Landing web page” shall mean a web page provided when a uniform resource locator (URL) request contains only a top level domain name (e.g., the web page provided when only the URL creditcards.com is provided to the browser). The addition of a scheme name (e.g. http, www), as well as “://” shall not obviate the status as a URL containing only a top level domain.

“Product”, in terms of showing, displaying, and/or advertising on a web page, shall mean a physical good, a service offered (e.g., issuance of a credit card), and/or a financial instrument. Product thus shall not be limited to just physical goods.

“Advertising credit” shall mean compensation, in any form, provided to a first legal entity from a second legal entity associated with the first legal entity showing products to consumers.

“Providing . . . a web page” shall mean providing a coded document (e.g., HTML, Java script) that a browser program uses to populate a browser window. The web page provided defines a viewable area, and may have sub-areas dedicated to “banner” advertisement provided from third parties; however, providing of a “banner” advertisement to fill a sub-area of a web page shall not be considered “providing . . . a web page.”

“Beacon packet” shall mean data that is stored in associate with a browser such that the browser saves state information regarding previous accesses to websites. A cookie is an example of a “beacon packet”, but other implementations are also possible.

“Local”, in relation to a computer and associated display device, shall mean the display device resides within one meter of the computer.

“Remote”, in relation to a computer and associate display device, shall mean the display device resides greater than one kilometer from the computer.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various example embodiments are directed to systems and methods to provide attribution to an operator of an aggregator website in the situation where a consumer is shown a product initially by way of the aggregator's website, but where the consumer navigates to the vendor website in such a way that no attribution is provided to the aggregator by way of the consumer access. The various example methods were developed in the context of an aggregator website advertising credit cards of multiple issuers. The description that follows is thus based on the developmental context; however, other examples are also given, and basing the description on the developmental context shall not be read as a limitation of the applicability of the example methods and systems. The methods and systems may find application in a host of aggregator situations (e.g., airline flight scheduling across multiple airlines, hotel room scheduling across multiple hotel chains, purchasing of physical products, purchasing of intangible products, or purchasing of services). The specification first turns to an example system.

Example System

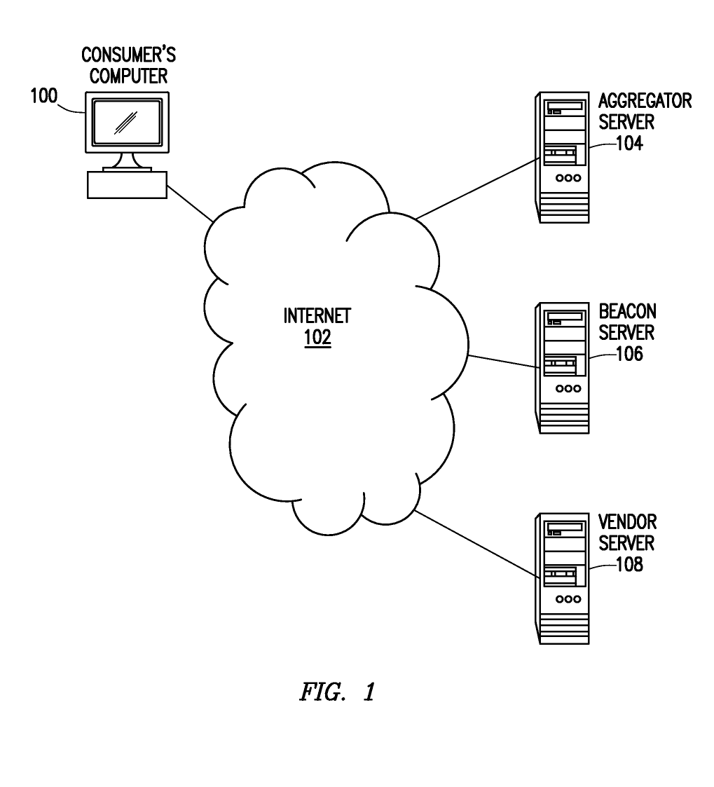

FIG. 1 shows a system in accordance with example embodiments. In particular, FIG. 1 shows a consumer's computer 100 coupled to a network, such as the Internet 102. Also coupled to the Internet 102 are aggregator server 104, beacon server 106, and vendor server 108. The consumer's computer 100 is illustrative of any device with which consumers browse for products over the Internet 102, such as a “desk top” computer, a laptop computer, and various battery operated mobile devices (e.g., APPLE® IPad, “smart” phones). The consumer's computer 100 is shown coupled directly to the Internet 102, but in practice the consumer's computer may communicatively couple to the Internet through various local and/or wide area networks, including a portion being a wireless network.

Also communicatively coupled to the Internet is the aggregator server 104. The aggregator server 104 is the computer system owned or controlled by a legal entity operating an aggregator website where the products from several different vendors are displayed and possibly available for purchase (the legal entity referred to as an “aggregator entity”). The aggregator server 104 may be a stand-alone computer system, a group of rack-mounted computer systems, or in the case of “cloud computing” the precise physical location and capability of the aggregator server 104 may change from day-to-day (e.g., based on the amount of computer resources needed at any given time). Thus, aggregator server 104 is illustrative of a computer system or group of computer systems that supplies web pages to requesting computers (such the consumer's computer), and may also be the computer system that accepts information associated with initiation of acquisition of a product. For example, the aggregator server 104 may accept from a consumer an application for a credit card in the case of the aggregator website advertising and accepting applications for credit cards of multiple issuers.

Still referring to FIG. 1, vendor server 108 is also communicatively coupled to the Internet 102. The vendor server 108 is the computer system owned or controlled by a legal entity operating as a vendor of products (referred to as a “vendor entity”, different than the “aggregator entity”). The products of the vendor entity are also displayed and/or sold by other legal entities (such as the aggregator entity). The vendor server 108 may be a stand-alone computer system, a group of rack-mounted computer systems, or in the case of “cloud computing” the precise physical location and capability of the vendor server 108 may change from day-to-day (e.g., based on the amount of computer resources needed at any given time). Thus, vendor server 108 is illustrative of a computer system or group of computer systems that supplies web pages to requesting computers (such the consumer's computer), and may also be the computer system that accepts information associated with initiation of acquisition of a product directly from the vendor. For example, in the case of a vendor entity being a specific bank that issues consumer credit cards, the vendor server 108 may be owned or controlled by the bank, and the vendor server 108 may accept from a consumer an application for issuance of a credit card.

Also communicatively coupled to the Internet 102 is the beacon server 106. The beacon server 106 is a computer system owned or controlled by a legal entity that assists aggregators and vendors in apportioning advertising and/or sales credit in internet-based transactions (referred to herein as the “beacon entity”). The beacon server 104 may be a stand-alone computer system, a group of rack-mounted computer systems, or in the case of “cloud computing” the precise physical location and capability of the beacon server 106 may change from day-to-day (e.g., based on the amount of computer resources needed at any given time). As will be discussed in greater detail below, the beacon server 106 places “beacon packets” on the consumer's computer 100 responsive to the consumer's computer 100 downloading and executing web pages from the aggregator server 104. Further, the beacon server 106 may read previously placed beacon packets on the consumer's computer 100 responsive to the consumer's computer 100 downloading and executing web pages from the vendor server 108. By analysis of the beacon packets, information can be determined that may assist the aggregator entity and vendor entity in apportioning advertising and/or sales credit.

Example Set of Communicative Exchanges

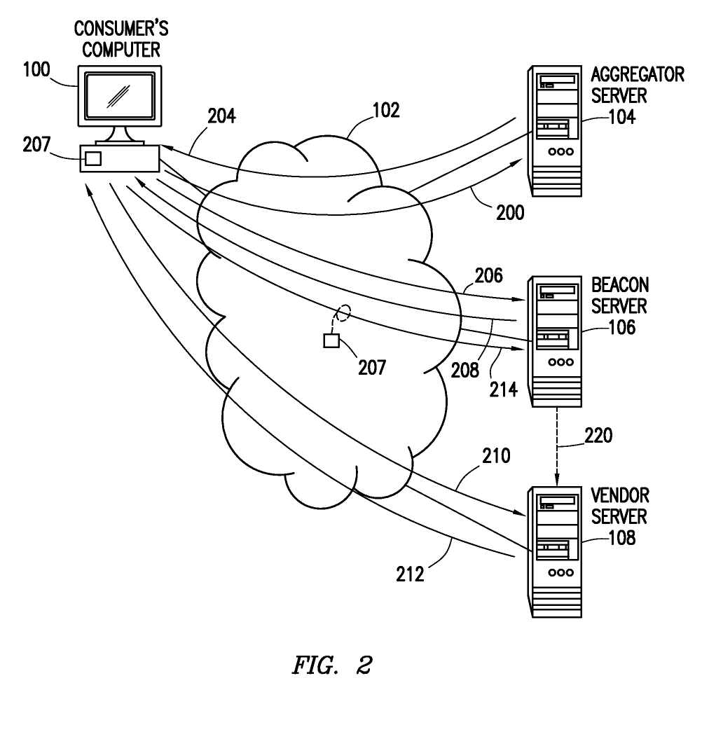

FIG. 2 shows an example set of exchanges between the consumer's computer 100 and the various servers in accordance with example embodiments. In particular, consider for purposes of discussion that the consumer, interacting with consumer's computer 100, navigates to the aggregator website (e.g., by typing a top level URL in an address bar of a web browser, or by clicking on a result from a search at a search engine website). More particularly, consider that the consumer contacts the aggregator by typing “www.creditcards.com” into the address bar of a web browser executing on the consumer's computer. Using the domain name, the consumer's computer 100 contacts the aggregator server 104, and the contact may be considered a request 200 for the aggregator server 104 to provide a web page. In practice, the consumer's computer 100 may first communicate with a domain name server (DNS) to resolve the domain name into an internet protocol (IP) address, but such an interaction is not shown so as not to unduly complicate the discussion. Responsive to the request 200, the aggregator server 104 may provide a web page to the consumer's computer, as shown by response 204. The response 204 may take many suitable forms, such as an HTML encoded webpage, various graphics images, Java scripts, and the like. In the example case of an aggregator entity operating an aggregator website advertising credit cards of multiple issuers (and perhaps accepting applications for credit cards), the response 204 may include information about specific credit card products of several different issuers. The consumer's computer 100, receiving and executing the web page, executes the example HTML and/or Java code and displays various images and text on a display device on the consumer's computer 100. Thus, by virtue of interaction with the aggregator server 104, the consumer may be shown or introduced to a particular product, such as the credit cards of various issuing banks.

In some cases, the aggregator server 104 may provide a landing web page of the aggregator responsive to a generic request. That is, the request 200 may not be for a specific web page, and thus a default or landing web page may be provided to the consumer's computer 100 by way of response 204. In other cases, the request 200 may be for a specific web page in the website maintained by the aggregator on the aggregator server 104. For example, a consumer may view the landing web page, and from the landing web page the consumer may select a hyperlink on the landing web page that navigates to a specific web page (e.g., a web page that provides further information about a specific product, such as Discover® student credit card). The request 200 and response 204 may be considered an example of either situation.

In accordance with example methods and systems, the web page provided in the response 204 has instructions and/or code embedded therein that, when executed by the consumer's computer 100, causes the consumer's computer 100 to communicate with the beacon server 106. The communication with the beacon server 106 shown by communication 206. Responsive to the communication 206, the beacon server 106 sends a beacon packet 207 to browser, which beacon packet 207 is stored in associate with the browser on the computer system in which the browser is executing. In the example case of FIG. 2, the beacon packet 207 is stored on the consumer's computer 100 responsive to communication 208. In other cases, such as situations where the browser is executing at a different physical location than where the consumer views the pages (e.g., a thin client acting as a terminal and communicating with another computer system, or the browser executed in the “cloud”), the browser stores the beacon packet in the location where the browser is executing. The balance of the discussion assumes the browser executing at the consumer's computer so as not to unduly complicate the discussion, but the alternate situations are contemplated.

The beacon packet 207 placed on the consumer's computer may take many forms (discussed more below). However, for purposes of the discussion in reference to FIG. 2, the beacon packet 207 contains information indicating that a web page from the aggregator server 104 was provided to the browser executing at the consumer's computer 100. More particularly, the beacon packet provided by the communication 208 indicates directly or indirectly that the consumer was shown a product by way of the web page provided by the aggregator server 106 (and therefore the aggregator entity).

The consumer may thus be introduced to a product of the vendor by way of the web page provided from the aggregator server 104. In some cases the consumer may have the ability to get a referral to a vendor server (e.g., kayak.com) for a purchase, the referral from the aggregator server 104. In other cases, the consumer may apply for and/or purchase the product directly from the aggregator entity by way of the aggregator server 104. However, many times consumers, after receiving the benefits provided by the aggregator website, will navigate directly to a website of the vendor. Thus, now consider that the consumer, after viewing the product by way of web pages provided by the aggregator server 104, navigates directly to the vendor website. That is, the browser of the consumer's computer requests a web page from the vendor server 108 (such as by request 210) in such a way that the request 210 does not include attribution of the request to the aggregator entity. Navigating to the website of the vendor maintained on the vendor server 108 such that the request does not include attribution to the aggregator may take many forms. For example, after viewing various credit cards for students on the aggregator website, including the Discover® student credit card, the consumer may navigate directly to the Discover® website by typing “www.discover.com” in the address bar of the web browser. Typing “www.discover.com” in the address bar of the browser navigates the browser to the Discover® website, but the Discover® website cannot tell from the request that the consumer viewed the product initially on an aggregator website.

Another example of navigating to the vendor website such that the request does not include attribution to the aggregator entity may involve a search engine. That is, after viewing the product on web pages provided by the aggregator server 104, the consumer may navigate to a search website (e.g., Bing®, Google®), initiate a search for the vendor, and then navigate to the vendor website maintained on the vendor server 108 by clicking a hyperlink on the search results web page (the search interaction not specifically shown in FIG. 2). In this second example, the request 210 may contain attribution to the search engine producing the results, but the attribution nevertheless does not include attribution to the aggregator entity indicating the consumer initially viewed the product by way a web page provided by the aggregator server 104.

Responsive to the request 210, the vendor server 108 may provide a web page, as shown by response 212. In accordance with the example systems, however, the web page provided by the vendor server 108 in the response 212 has instructions and/or code embedded therein that, when executed by the consumer's computer 100, causes the consumer's computer 100 to communicate with the beacon server 106. The communication with the beacon server 106 shown by communication 214. Responsive to the communication 214, the beacon server 106 determines whether a beacon packet 207 has been previously placed on the consumer's computer 100 related to the aggregator and vendor entities. If the beacon packet indicates that the consumer was shown the product by way of the aggregator server 104 prior to the consumer's computer navigating to the vendor server 108 regarding the same product, then the beacon server 106 communications the information to the vendor server 108 such that the aggregator entity can receive lead generation credit (the communication illustratively shown by dashed line 220). In the example situation of FIG. 2, the beacon server 106 finds beacon packet 207, and thus lead generation credit may be provided by the vendor entity responsive to communication 220.

The Interactions in Greater Detail

Now that the reader has an understanding of the overall system, the discussion turns to each interaction between the consumer's computer 100 and the various servers in greater detail, starting with the consumer's computer interacting with the aggregator server 104. In particular, consumer's computer 100 may request a web page from the aggregator server 104. The request may be generic (e.g., typing “www.creditcards.com” into an address bar of the web browser), or the request may be for a specific page. An example of requesting a specific page may involve clicking a link within a web page provided by the aggregator server 104 that requests a specific page, such as “www.creditcards.com/college-students.php” that may, for example, provide a specific web page for student credit cards. Of course, the specific web page address could also be typed directly into the address bar of the web browser, and thus a clicking on a hyperlink to request a specific page is not strictly required.

Regardless of how the consumer's computer navigates to a web page provided by the aggregator server 104, and regardless of what specific web page is provided (e.g., landing web page, web page several levels deep within the website), if the consumer is shown a product on the web page for which the aggregator entity would like advertising credit, in accordance with example embodiments the web page includes embedded code that, when executed by the consumer's computer, causes the consumer's computer to contact the beacon server 106 (i.e., communication 206). In one example system, the embedded code is a set of embedded HTML code, such as shown in pseudo code form in Table 1 below.

TABLE 1

<img
src=“ [beaconURL].com/init.php?mid=[MEMBER_ID]&cid=
[CAMPAIGN_ID]”
width=“1”
height=“1”
border=“0”
alt=“beaconinit”>

That is, when downloaded and executed by the consumer's computer 100, the embedded code causes the consumer's computer 100 to contact the beacon server 106 at the “[beaconURL].com” URL address, and the communication to the beacon server 106 includes a value indicative of a MEMBER_ID and a value indicative of a CAMPAIGN_ID. The example MEMBER_ID identifies the aggregator entity. It is noted that multiple, distinct aggregator entities may participate (as discussed more below), and thus FIGS. 1 and 2 should not be read to imply that only one aggregator entity may participate. Moreover, each aggregator entity may advertise the multiple product lines, and thus the communication to the beacon server 106 may include an indication of the product line to which the communication applies, referred to as a campaign. In other embodiments, the identity of the aggregator may be implied in the communication (e.g., based on the “[beaconURL]” used, or based on a specific page “requested” in the communication to the beacon server), thus the example MEMBER_ID may be omitted in example cases. Likewise, the example CAMPAIGN_ID identifies the campaign, and may be implied in the communication in some form and thus may be omitted in example cases. In yet other cases, the contact with the beacon server 106 may be triggered by a Java script embedded in the web page provided by the aggregator server 104, the Java script executed by the consumer's computer 100.

Table 1 above shows an example set of information that may be included in embedded code, and thus communicated to the beacon server 106. However, additional and/or different information may also be included. For example, the embedded code may include further information to be communicated to the beacon server, such as: the exact pages of the aggregator website viewed; specific products viewed; an indication of how the consumer found the aggregator's website (e.g., determined through click-through attribution discussed below); and FICO score of the consumer (e.g., determined by identity of the website referring the consumer to the vendor's website).

Regardless of the precise content of the communication, responsive to the communication the beacon server 106 places a beacon packet on the consumer's computer. The beacon packet may be implemented as a “cookie” used by browsers to remember states of previous activity (which may also be referred to as a HTTP cookie, a web cookie, a tracking cookie, or a browser cookie). Other implementations are possible so long as the beacon packet can be associated with the browser and save state information. This specification refers to the use as a beacon packet to differentiate from related-art cookies, and the specification includes a section below to help the reader understand the distinctions in use regarding cookies in the “click-through” attribution context. In some cases, the beacon packet is small file that contains a limited number of bytes of information (e.g., 255 bytes or less). The beacon packet may comprise information such as: a beacon packet “name”; a value associated with the beacon packet name; a date indicating when the beacon packet was provided to the consumer's computer; a date in the future when the beacon packet expires; and a domain name which placed the beacon packet. In the example case of HTML code executed by the consumer's computer 100 contacting the beacon server 106 by way of a HTTP communication, the response may be a HTTP response instructing the browser program on the consumer's computer 100 to create the beacon packet. For example, the following pseudo code HTTP response may be sent from the beacon server 106 to the consumer's computer 100.

TABLE 2

Set-Cookie: [name]=[value];
Domain=[beaconURL].com;
Path=[specific path within beacon server]
Expires=[future date];
Secure

The example pseudo code response of Table 2 causes the browser program of the consumer's computer 100 to create a beacon packet with a name/value pair, a domain to which the beacon packet can be returned, a specific path to which the beacon packet can be returned, a future date at which the beacon packet expires, and indicating that communication between the consumer's computer 100 and the beacon server 106 be by way of a secure connection. It is noted that the pseudo code of Table 2 is merely an example. The beacon packet may contain varied information, and one of ordinary skill in the art, understanding the beacon packet usage after reading and understanding this specification, could fashion a HTTP response to trigger creation of a beacon packet suitable for use in the example systems and methods.

Now consider again that, after the consumer views the products by way of the aggregator website and beacon packet has been created, the consumer navigates directly to the vendor website in such a way that consumer's computer does not indicate in the navigation that attribution should be provided to the aggregator entity. For example, the consumer may navigate directly to the aggregator website by typing a URL directly in the address bar of the web browser (e.g., “www.discover.com”), or by clicking a hyperlink on the search results web page as discussed above.

Responsive to the request 210, the vendor server 108 provides a web page (response 212). In the example systems the web page provided by the vendor server 108 has instructions and/or code embedded therein that, when executed by the consumer's computer 100, causes the consumer's computer 100 to communicate with the beacon server 106. In one example system, the embedded code is a set of embedded HTML code, such as shown in pseudo code form in Table 3 below.

TABLE 3

<img
src=“ [beaconURL].com/resp.php?mid=[MEMBER_ID]&act=
[ACTIVITY_CODE]”
width=“1”
height=“1”
border=“0”
alt=“beaconresp”>

That is, when downloaded and executed by the consumer's computer 100, the embedded code causes the consumer's computer 100 to contact the beacon server 106 at the “[beaconURL].com” URL address, and the communication to the beacon server 106 includes a value indicative of a MEMBER_ID and a value indicative of an ACTIVITY_CODE. The example MEMBER_ID identifies the vendor entity. The example ACTIVITY_CODE value identifies the action taken by the consumer associated with the web page provided by the vendor server 108. For example, the ACTIVITY_CODE value may indicate: the consumer was provided a landing web page from the vendor server 108; the consumer was provided a web page comprising an application form (in the example case of the vendor being a bank issuing consumer credit cards); the consumer completed an application form; approval for credit for the consumer has been approved; and approval for credit has been denied.

Table 3 above shows an example set of information that may be included in embedded code, and thus communicated to the beacon server 106. However, additional and/or different information may also be included. For example, the embedded code may include further information to be communicated to the beacon server, such as: the exact page locations on the vendor's website viewed; specific vendor products viewed; an indication of how the consumer found her way to the vendor's website (e.g., determined through click-through attribution discussed below); and FICO score of the consumer (e.g., determined by identity of the website referring the consumer to the vendor's website).

The web browser executing on the consumer's computer 100, in contacting the beacon server 106 for the second time (in this example) also sets up a channel of communication between the beacon server 106 and the consumer's computer 100. By way of the channel of communication, the beacon server requests a copy of any previously set beacon packet(s). In response, the web browser of the consumer's computer 100 sends a copy of the beacon packet 207 (as shown in FIG. 2, the beacon packet 207 within the Internet 102 “cloud”). Thus, associated with the communication 214 the beacon server 106 is provided information about web pages provided by the vendor server 108, along with information (carried in the beacon packet 207) regarding previous accesses by the consumer's computer 100 to web pages provided by the aggregator server 104. It is noted that the consumer's web browser will provide the beacon packet 207 to the beacon server 106; however, neither the aggregator server 104, nor the vendor server 108, has the ability to read the beacon packet 207.

Programs executing on the beacon server 106 may then analyze the information. For example, the beacon server 106 may be able to determine that the consumer, by way of the consumer's computer 100, first viewed the product on the aggregator website, before then viewing, applying for, and/or purchasing the product directly by way of the vendor server 108. Thus, in the example situation of determining that the consumer viewed the product initially by way of the aggregator website, advertising credit may be attributed to the aggregator entity by the vendor entity (e.g., the vendor entity may pay a “finder's fee” or lead generation fee, may pay a portion of the sales price of the product as a commission to the aggregator entity, or may attribute a portion of an advertising budget to be paid to the aggregator entity).

Moreover, given that in at least some embodiments the beacon packet 207 may contain date and/or time information, software executing on the vendor server 106 may be able to determine information regarding the path the consumer takes to arrive at viewing a product directly on the vendor's website, and adjust the advertising credit accordingly. For example, if in analyzing the information associate with beacon packet 207 the beacon server 106 determines that the consumer visited the vendor's website (after visiting the aggregator's website) within a predetermined short period of time (e.g., 10 second, 10 minutes), more advertising credit may be attributed to the aggregator entity than if the analysis of the beacon server 106 indicates a long period of time (e.g., 10 days). As yet another example, if in analyzing the information associated with the beacon packet 207 the beacon server 106 determines that the consumer visited the vendor website after visiting the aggregator's website, but the consumer performed a click-through operation on a third-party website to arrive at the vendor's website, less advertising credit may be attributed to the aggregator entity than if the consumer navigated directly to the vendor's website after viewing the aggregator's website.

Further still, the example interactions of FIG. 2 are with respect to a single visit to the aggregator website by the consumer's computer; however, the consumer may visit the aggregator's website multiple times in a day, or over the course of several days, and each time a beacon packet may be triggered. Again, in the contact by the consumer's computer 100 with the beacon server 106 on a second visit (even to the same web page), the beacon server 106 may set a subsequent beacon packet that notes the date and/or time of the second visit. In the later communication with the beacon server 106 by the consumer's computer 100 responsive to code embedded in web pages from the vendor server 108, the beacon server 106 may request all the beacon packets previously set. In analyzing the information associated with the beacon packets, software on the beacon server 106 may determine a pattern of web pages visited by the consumer prior to viewing web pages from the vendor server 108. In other cases, the raw information associated with the beacon packet(s) may be provided to the vendor entity, and the vendor entity may parse the information to determine the patterns of web pages visited by the consumer.

Regardless of the information gleaned by the beacon server 106 from the analysis of the beacon packet 207, in the example systems the information is passed to the vendor server 108, again as shown by communication 220. Communication 220 may take many forms. In one example situation, communication 220 may be a message sent from the beacon server 106 to the vendor server 108 contemporaneously with the consumer's computer 100 contact with the beacon server 106 responsive to vendor web pages. For example, the beacon server 106 may send an electronic mail message over the internet 102 (this communication not specifically shown so as not to unduly complicate the figure). In other cases, the beacon server 106 may store information, and the vendor entity may periodically log into the beacon server 106 and download the information. Any of a further variety of communication systems and methods may be used to communicate the information to the vendor entity from the beacon server 106. Moreover, aggregator entities as well may be provided the information gleaned by the beacon server 106.

Multiple Aggregators

The example embodiments discussed to this point have assumed a single aggregator entity and thus a single aggregator server 104; however, in other example systems multiple aggregator entities may advertise products for the vendor entity, and thus multiple aggregator entities may participate in the use of beacon packets and related tracking.

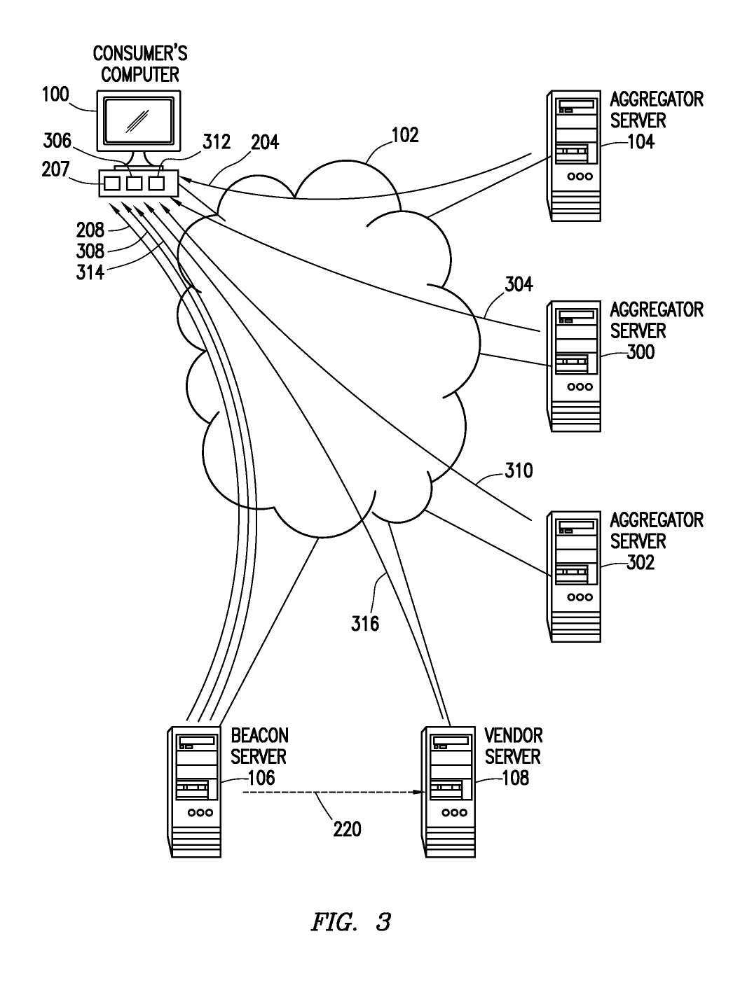

FIG. 3 shows a system in accordance with further example embodiments. In particular, FIG. 3 shows the consumer's computer 100 coupled to Internet 102, as well as aggregator server 104, beacon server 106, and vendor server 108. In the embodiments of FIG. 3, however, two additional aggregator servers 300 and 302 are shown, and likewise the additional aggregator servers 300 and 302 are coupled to the Internet 102.

Consider, for purposes of discussion, that each aggregator server 104, 300, and 302 are owned or controlled by different aggregator entities. Further consider that each aggregator server 104, 300, and 302 holds a website that displays products of the vendor entity (that owns or controls the vendor server 108), and that each aggregator entity participates (along with the vendor entity) in the beacon program. Finally, consider that a consumer, interacting with the consumer's computer 100, initially views a product by way of a web page provided by aggregator server 104. Responsive to the instructions and/or code embedded in the web page provided by aggregator server 104, the consumer's computer 100 contacts the beacon sever 106, and a beacon packet is placed on the consumer's computer 100. So as not to unduly complicate the figure, in FIG. 3 only the communications to the consumer's computer 100 are shown. Thus, response 204 delivers the requested web page to the consumer's computer 100, and likewise communication 208 creates the beacon packet 207 that identifies the first aggregator entity and a campaign.

Now consider that the consumer, interacting with the consumer's computer 100, next views the product by way of a web page provided by aggregator server 300. Thus, the consumer's computer sends a request, and a response 304 provides the requested web page. Again, since the aggregator entity that owns or controls the aggregator server 300 participates in the beacon program, the web page provided by aggregator server 300 likewise has the embedded code and/or instructions which causes the consumer's computer 100 to contact the beacon server 106. The contact identifies the second aggregator entity (e.g., uses a distinct MEMBER_ID) and the campaign (which campaign is the same as for the first aggregator entity in this example), and the beacon server 106 creates a beacon packet 306 responsive to response 308. The beacon packet 306 may not only identify the date and/or time when the consumer's computer 100 was provided the web page from the aggregator server 300, but may also identify the aggregator entity that owns or controls the aggregator server 300 and the campaign.

Now consider that the consumer, interacting with the consumer's computer 100, after viewing the product by way of web pages from server 104 and server 300, next views the product by way of a web page provided by aggregator server 302. Thus, the consumer's computer sends a request, and a response 310 provides the requested web page. Again, since the aggregator entity that owns or controls the aggregator server 302 participates in the beacon program, the web page provided by aggregator server 302 likewise has the embedded code and/or instructions which causes the consumer's computer 100 to contact the beacon server 106. The contact identifies the third aggregator entity (e.g., uses a distinct MEMBER_ID) and the campaign (which campaign is the same as for the first and second aggregator entities in this example), and the beacon server 106 creates a beacon packet 312 responsive to response 314. The beacon packet 312 may not only identify the date and/or time when the consumer's computer 100 was provided the web page from the aggregator server 302, but may also identify the aggregator entity that owns or controls the aggregator server 302 and the campaign.

Finally, consider that the consumer now navigates directly to a website of the vendor entity on the vendor server 108 in such a way that that the request for the web page from the vendor server 108 does not contain attribution to any of the aggregator entities. Responsive to the request for the web page from the vendor server 108, the web page is provided to the consumer's computer (response 316). As before, the web page provided from the vendor server 108 includes imbedded instructions and/or code that, when executed by the web browser program, cause the web browser program to contact the beacon server 106.

Responsive to the communication from the consumer's computer 100 to the beacon server 106 caused by code within the web page provided by the vendor server 108, the beacon server 106 requests beacon packets related to the campaign. Responsive to the request, and in the particular example of FIG. 3, the consumer's computer 100 provides all three beacon packets 207, 306, and 312. Programs executing on the beacon server 106 may then analyze the information in the beacon packets as well as other information previously provided from the aggregators. For example, the beacon server 106 may be able to determine that the consumer, by way of the consumer's computer 100, first viewed the product on multiple aggregator websites before then viewing, applying for, and/or purchasing the product directly by way of the vendor server 108. Thus, in the example situation of determining that the consumer viewed the product initially by way of the aggregator websites, advertising credit may be attributed to all the aggregator entities by the vendor entity (e.g., the vendor entity may pay a “finder's fee” or lead generation fee, may pay a portion of the sales price of the product as a commission to the aggregator entity, or may attribute a portion of an advertising budget to be paid to the aggregator entities).

Moreover, given that in at least some embodiments the beacon packets 207, 306, and 312 may contain date and/or time information, software executing on the vendor server 106 may be able to determine the logical path that the consumer took to arrive at the vendor website. Stated otherwise, the system may determine a path, web page-to-web page, that a consumer traversed to arrive at the vendor's website, even when the web pages in the path are supplied from different servers owned or controlled by different aggregator entities. In the example discussed with respect to FIG. 3, software executing on the beacon server 106 may be able to determined that the consumer first viewed the product by way of web pages from the aggregator server 104, and then viewed the product by way of web pages from the aggregator server 300, and then viewed the product by way of web pages from the aggregator server 302. As before, in other cases the raw information may be provided to the vendor entity, and the vendor entity may make the various determinations.

Further still, in situations where many aggregator entities participate, and where many consumers view the product on many aggregator websites, it may be able to determine which aggregator entities are better at attracting consumers to the aggregator's websites, and/or which aggregator entities better channel the consumers to the vendor's website. That is, the beacon server 106 or the vendor entity may be able to determine statistical rankings of aggregator entities (e.g., which aggregators have higher rates of directing the traffic to the vendor website after visit to the aggregator web pages).

Regardless of the information gleaned by the beacon server 106 from the analysis of the beacon packets, in the example systems the information is passed to the vendor server 108, again as shown by communication 220. Thus, advertising credit may be attributed to the aggregator entities by the vendor entity (e.g., the vendor entity may pay “finder's fees” or lead generation fees, may pay a portion of the sales price of the product as a commission to the aggregator entities based on the statistics, or may attribute a portion of an advertising budget to be paid to the aggregator entities based on the statistics).

Related-Art Click Through Attribution

In order to differentiate the example systems from the related-art, the specification briefly discussed “click-through” attribution and the use of cookies in the related-art. That is, related-art advertising attribution is based on a click-through model where a URL has embedded therein an indication of from where a user originated a request for a web page. Consider, as an example, a banner advertisement for a product on a web page. A consumer, viewing the banner advertisement, may want more information, and thus “clicks” on the banner advertisement. By “clicking” on the banner advertisement, the consumer's browser is redirected to the vendor's website, but the URL includes not only the high-level URL for the vendor's website, but also data attributing the source of the navigation to the publisher. Responsive to the attribution information, the vendor's website may place a cookie on the consumer's machine with a date and/or time, and including information that the consumer was led to the vendor's website by the publisher. Thus, the vendor is informed of the publisher's role based on information in the URL. Should the consumer leave the vendor's website, later return, and/or purchase the product on the vendor's website, by reading the previously placed cookie the vendor may make attribution to the publisher for the lead. Although discussed in terms of a banner advertisement “click-through”, the same is true for any hyperlink in a web page of a publisher.

In the related-art then, the vendor places the cookie, and likewise the vendor later reads the cookie. Cookie technology does not allow a separate computer systems under domains different from the vendor to read the cookie placed by the vendor. Moreover, because the vendor places the cookie, the web pages of the vendor in the related-art do not contain embedded code to cause the consumer's computer to contact an additional server that places the cookie. Stated otherwise, the vendor may provide a web page to the consumer's machine, and the vendor may request the consumer's web browser to create a cookie, but the web page itself delivered to the consumer's machine does not contain embedded code which triggers contact with a server outside the vendor's domain for cookie creation.

Further still, though publishers in the related-art may place their own cookies, neither the vendor nor the other unrelated publishers may see those cookies. Thus, an ability to gather statistics regarding the path of travel of a consumer from publisher-to-publisher (without clicking through to the vendor's website) is not possible through related-art implementations of cookie technology.

Example Flow Diagrams and Example Computer System

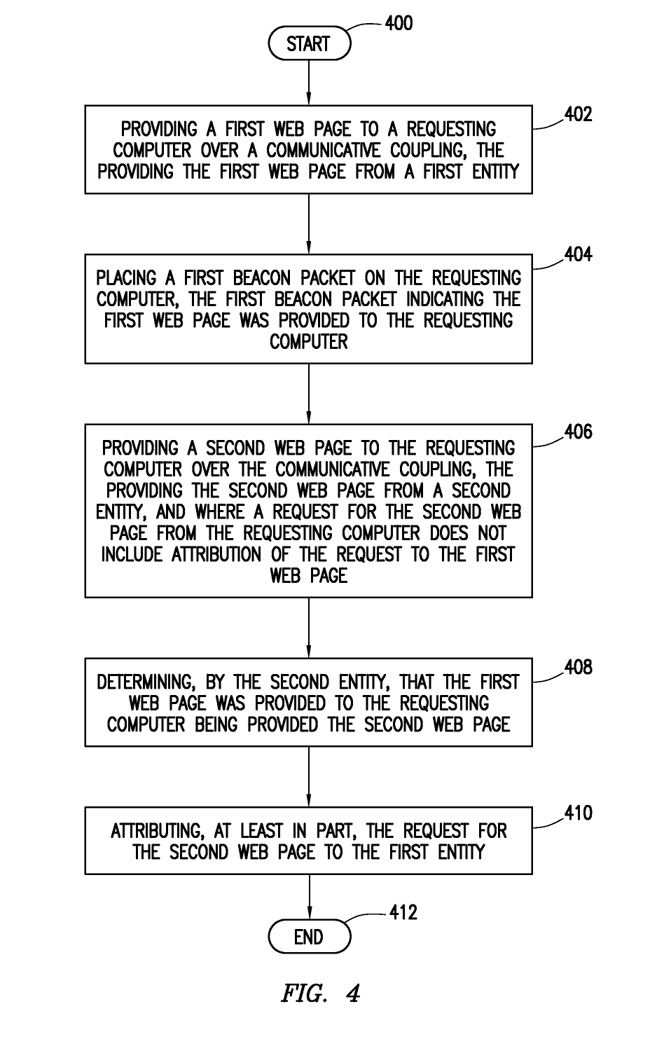

FIG. 4 shows a method, some of which may be executed by software, in accordance with example embodiments. In particular, the method starts (block 400) and comprises: providing a first web page to a requesting computer over a communicative coupling, the providing the first web page from a first entity (block 402); placing a first beacon packet on the requesting computer, the first beacon packet indicating the first web page was provided to the requesting computer (block 404); providing a second web page to the requesting computer over the communicative coupling, the providing the second web page from a second entity different than the first entity, and where a request for the second web page from the requesting computer does not include attribution of the request to the first web page (block 406); determining, by the second entity, that the first web page was provided to the requesting computer prior to the requesting computer being provided the second web page (block 408); and attributing, at least in part, the request for the second web page to the first entity (block 410). Thereafter, the example method may end (block 412), possibly to be immediately restarted.

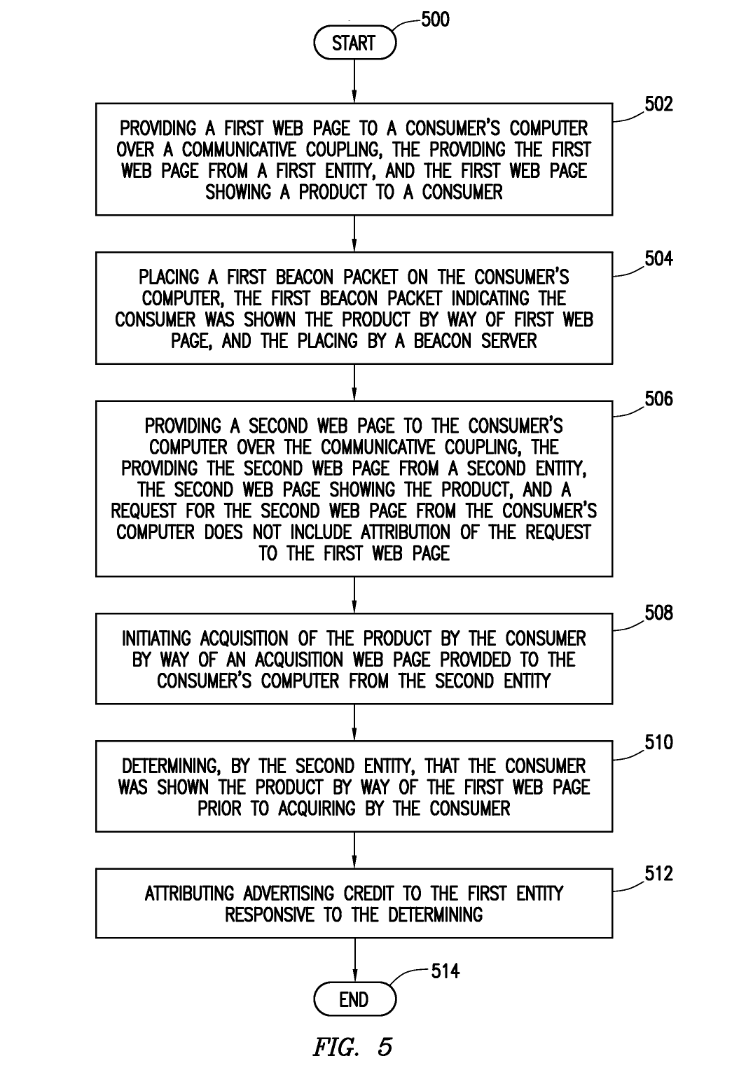

FIG. 5 shows a method, some of which may be executed by software, in accordance with still further example embodiments. In particular, the method starts (block 500) and comprises: providing a first web page to a consumer's computer over a communicative coupling, the providing the first web page from a first entity, and the first web page showing a product to a consumer (block 502); placing a first beacon packet on the consumer's computer, the first beacon packet indicating the consumer was shown the product by way of first web page, and the placing by a beacon server (block 504); providing a second web page to the consumer's computer over the communicative coupling, the providing the second web page from a second entity different than the first entity, the second web page showing the product, and a request for the second web page from the consumer's computer does not include attribution of the request to the first web page (block 506); initiating acquisition of the product by the consumer by way of an acquisition web page provided to the consumer's computer from the second entity (block 508); determining, by the second entity, that the consumer was shown the product by way of the first web page prior to initiating acquisition by the consumer (block 510); and attributing advertising credit to the first entity responsive to the determining (block 512). Thereafter, the example method may end (block 514), possibly to be immediately restarted.

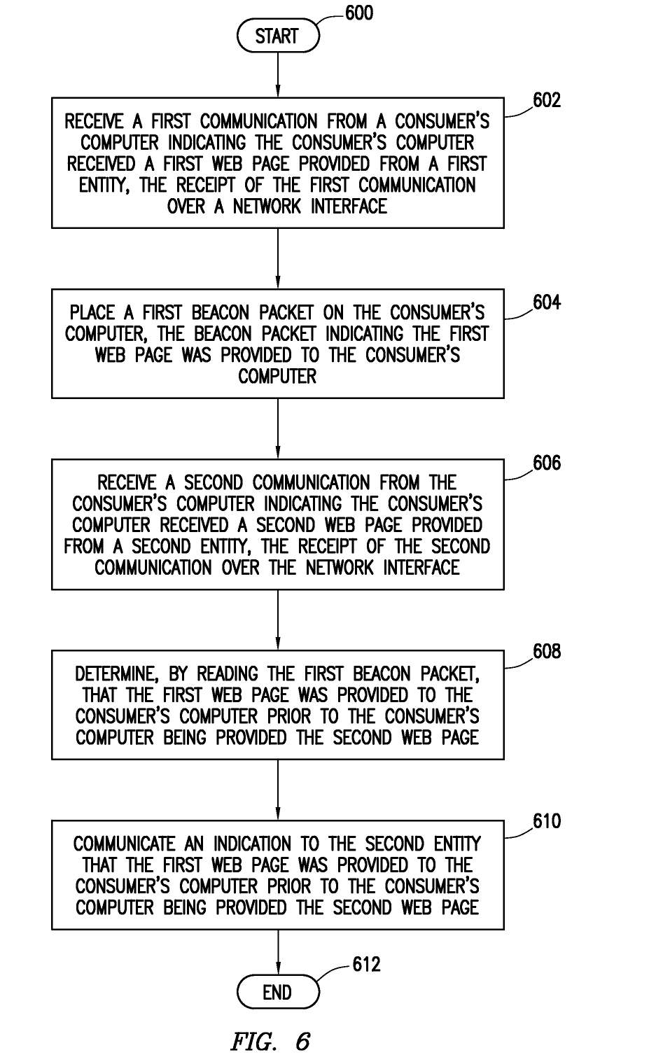

FIG. 6 shows a method, some of which may be executed by software, in accordance with example embodiments. The method may start (block 600) and instructions may cause the processor to: receive a first communication from a consumer's computer indicating the consumer's computer received a first web page provided from a first entity, the receipt of the first communication over a network interface (block 602); place a first beacon packet on the consumer's computer, the beacon packet indicating the first web page was provided to the consumer's computer (block 604); receive a second communication from the consumer's computer indicating the consumer's computer received a second web page provided from a second entity different than the first entity, the receipt of the second communication over the network interface (block 606); and responsive to the receipt of the second communication determine, by reading the first beacon packet, that the first web page was provided to the consumer's computer prior to the consumer's computer being provided the second web page (block 608); and communicate an indication to the second entity that the first web page was provided to the consumer's computer prior to the consumer's computer being provided the second web page (block 610). The example method may then end (block 612), in some cases to be immediately restarted.

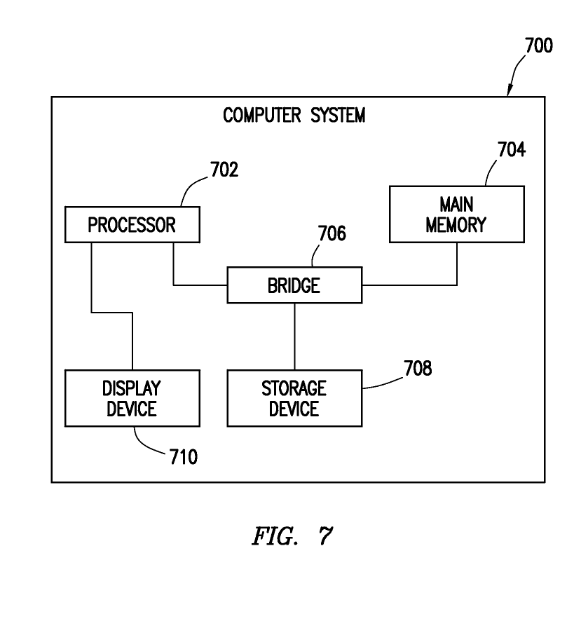

FIG. 7 shows a computer system 700, which is illustrative of any of the various computer systems and/or servers discussed above. The computer system 700 comprises a processor 702, and the processor couples to a display device 710 and a main memory 704 by way of a bridge device 706. It is on the display device 710 that the various web pages may be viewed by the a consumer, or upon which statistics derived from analysis of beacon packets may be shown. Moreover, the processor 702 may couple to a long term storage device 708 (e.g., a hard drive, solid state disk, memory stick, optical disc) by way of the bridge device 706. Programs executable by the processor 702 may be stored on the storage device 708, and accessed when needed by the processor 702. In some cases, the programs are copied from the storage device 708 to the main memory 704, and the programs are executed from the main memory 704. Thus, the main memory 704, and storage device 708 shall be considered computer-readable storage mediums.

From the description provided herein, those skilled in the art are readily able to combine software created as described with appropriate general-purpose or special-purpose computer hardware to create a computer system, a server system, and/or computer sub-components in accordance with the various embodiments, to create a computer system, a server system, and/or computer sub-components for carrying out the methods of the various embodiments, and/or to create a non-transitory computer-readable storage medium (i.e., other than a signal traveling along a conductor or carrier wave) for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
providing a first web page to a requesting computer over a communicative coupling, the providing the first web page from a first entity;
placing a first beacon packet on the requesting computer, the first beacon packet indicating the first web page was provided to the requesting computer;
providing a second web page to the requesting computer over the communicative coupling, the providing the second web page from a second entity different than the first entity, and where a request for the second web page from the requesting computer does not include attribution of the request to the first web page;
determining, by the second entity, that the first web page was provided to the requesting computer prior to the requesting computer being provided the second web page; and
attributing, at least in part, the request for the second web page to the first entity.

2. The method of claim 1 further comprising at least one selected from the group consisting of: displaying the first web page on a display device local to the requesting computer; displaying the first web page on a display device remote from the requesting computer.

3. The method of claim 1 wherein providing the first web page further comprises providing a landing web page of the first entity.

4. The method of claim 1 wherein providing the first web page further comprises providing the first web page responsive to selecting a hyperlink on a landing web page provided to the requesting computer, the landing web page provided from the first entity.

5. The method of claim 1 wherein placing the first beacon packet further comprises:
executing code embedded in the first web page, the executing by the requesting computer, and the code causing the requesting computer system to communicate with a beacon server; and
placing the first beacon packet on the requesting computer by the beacon server responsive to the communication from the requesting computer.

6. The method of claim 5 wherein determining that the first web page was provided to the requesting computer prior to the requesting computer being provided the second web page further comprises:
executing code embedded in the second web page, the executing by the requesting computer, and the code causing the requesting computer to communicate with the beacon server; and
reading the presence of the first beacon packet by the beacon server responsive to the requesting computer communicating with the beacon server.

7. The method of claim 6 wherein attributing the request for the second web page to the first entity further comprises communicating an indication to the second entity that the first web page was provided to the requesting computer prior to the second web page.

8. The method of claim 1 wherein placing the first beacon packet on the requesting computer further comprises placing the first beacon packet indicating at least one selected from the group consisting of: a date; and a time.

9. The method of claim 1 further comprising:
providing a third web page to the requesting computer over the communicative coupling, the third web page provided prior to providing the second web page, and the providing the third web page from a third entity different than both the first and second entities;
placing a second beacon packet on the requesting computer, the second beacon packet indicating the third web page was provided to the requesting computer;
wherein determining further comprises determining, by the second entity, that the first web page and the third web page were provided to the requesting computer prior to the requesting computer being provided to the second web page; and
wherein the attributing further comprises attributing the request for the second web page to the first entity and the third entity.

10. A method comprising:
providing a first web page to a consumer's computer over a communicative coupling, the providing the first web page from a first entity, and the first web page showing a product to a consumer;
placing a first beacon packet on the consumer's computer, the first beacon packet indicating the consumer was shown the product by way of first web page, and the placing by a beacon server;
providing a second web page to the consumer's computer over the communicative coupling, the providing the second web page from a second entity different than the first entity, the second web page showing the product, and a request for the second web page from the consumer's computer does not include attribution of the request to the first web page;
initiating acquisition of the product by the consumer by way of an acquisition web page provided to the consumer's computer from the second entity;
determining, by the second entity, that the consumer was shown the product by way of the first web page prior to initiating acquisition by the consumer; and
attributing advertising credit to the first entity responsive to the determining.

11. The method of claim 10 further comprising at least one selected from the group consisting of: displaying the first web page on a display device local to the consumer's computer; displaying the first web page on a display device remote from the consumer's computer.

12. The method of claim 10 further comprising:
providing a third web page to a consumer's computer over the communicative coupling, the providing the third web page from a third entity different than the first and second entities, and the third web page advertising the product;
placing a second beacon packet on the consumers computer, the second beacon packet indicating the consumer was shown the product by way of third web page, and the placing by the beacon server;
wherein determining further comprises determining, by the second entity, that the consumer was shown the product by way of the first web page and the second web page prior to initiating acquisition by the consumer; and
wherein the attributing further comprises attributing advertising credit to the first entity and the third entity.

13. The method of claim 10 wherein providing the first web page further comprises providing the first web page responsive to selecting a hyperlink on an initial web page provided to the consumer's computer, the initial web page provided from the first entity.

14. The method of claim 10 wherein placing the first beacon packet further comprises:
executing code embedded in the first web page, the executing by the consumer's computer, and the code causing the consumer's computer to communicate with the beacon server; and
placing the first beacon packet on the consumers computer by the beacon server responsive to the communication from the consumer's computer.

15. The method of claim 14 wherein determining that the consumer was shown the product by way of the first web page prior to initiating acquisition further comprises:
executing a piece of code embedded in the second web page, the executing by the consumer's computer, and the piece of code causing the consumer's computer to communicate with the beacon server; and
reading the presence of the first beacon packet by the beacon server responsive to the consumer's computer communicating with the beacon server.

16. The method of claim 15 wherein attributing advertising credit further comprises communicating an indication to the second legal entity that the consumer was shown the product by way of the first web page prior to the consumer being shown the product by way of the second web page.

17. The method of claim 10 wherein placing a beacon packet on the consumer's computer further comprises placing the beacon packet indicating at least one selected from the group consisting of: a date; and a time.

18. The method of claim 10 wherein initiating acquisition further comprises at least one selected from the group consisting of: providing purchase information by way of the acquisition web page; and applying for credit for the product by way of the acquisition web page; and applying for the product by way of the acquisition web page.

19. A computer system comprising:
a processor;
a memory coupled to the processor; and
a network interface coupled to the processor;
the memory storing a program that, when executed by the processor, causes the processor to:
receive a first communication from a consumer's computer indicating the consumer's computer received a first web page provided from a first entity, the receipt of the first communication over the network interface;
place a first beacon packet on the consumer's computer, the beacon packet indicating the first web page was provided to the consumer's computer;
receive a second communication from the consumer's computer indicating the consumer's computer received a second web page provided from a second entity different than the first entity, the receipt of the second communication over the network interface; and responsive to the receipt of the second communication
determine, by reading the first beacon packet, that the first web page was provided to the consumer's computer prior to the consumer's computer being provided the second web page; and
communicate an indication to the second entity that the first web page was provided to the consumer's computer prior to the consumer's computer being provided the second web page.

20. The computer system of claim 19 wherein the program causes the processor to extract from the first communication at least one selected from the group consisting of: an indication of an identity of the first entity; a campaign identifier; an indication of an identity of the first web page within a web site of the first entity.

21. The computer system of claim 19 wherein when the processor places the first beacon packet on the consumer's computer, the program causes the processor to place the first beacon packet indicating at least one selected from the group consisting of: a date the first communication was received; a time first communication was received; and a campaign identifier.

22. The computer system of claim 19 wherein the program further causes the processor to:
receive a third communication from a consumer's computer indicating the consumer's computer received a third web page provided from a second entity different than the first entity, the receipt of the third communication prior to receipt of the second communication, and the receipt of the second communication over the network interface;
place a second beacon packet on the consumer's computer, the second beacon packet indicating the third web page was provided to the consumer's computer;
determine, responsive to the second communication and by reading the second beacon packet, that the third web page was provided to the consumer's computer prior to the consumer's computer being provided the second web page; and
communicate an indication to the second entity that the third web page was provided to the consumer's computer prior to the consumer's computer being provided the second web page.

23. The computer system of claim 19 wherein the program further causes the processor to determine a pattern of web pages provided by the consumer's computer leading to the second web page.

24. A computer system comprising:
a processor;
a memory coupled to the processor; and
a network interface coupled to the processor;
the memory storing a program that, when executed by the processor, causes the processor to:
receive a plurality of communications from a consumer's computer indicating the consumer's computer received a plurality of web page from a respective plurality of distinct entities, the receipt of the first communication over the network interface;
place a plurality of beacon packets on the consumer's computer, each beacon packet indicating a respective web page was provided to the consumer's computer;
receive a second communication from the consumer's computer indicating the consumer's computer received a second web page provided from a second entity different than the plurality of entities, the receipt of the second communication over the network interface; and responsive to the receipt of the second communication
determine, by reading the plurality beacon packets, that the plurality of web pages were provided to the consumer's computer prior to the consumer's computer being provided the second web page; and
communicate an indication to the second entity entities that provided the respective plurality of web pages to the consumer's computer prior to the consumer's computer being provided the second web page.

25. The computer system of claim 24 wherein the program causes the processor to extract from the each of the plurality of communications at least one selected from the group consisting of: an indication of an identity of the each respective entity; and a campaign identifier.

26. The computer system of claim 24 wherein when the processor places each beacon packet of the plurality of beacon packets, the program causes the processor to place at least one selected from the group consisting of: a date a respective communication was received; a time a respective communication was received; a campaign identifier; and an indication of an identity an entity providing the respective web page of the plurality of web pages.

27. The computer system of claim 24 wherein the program further causes the processor to determine a pattern of web pages provided by the consumer's computer leading to the second web page.
